(19) United States
(12) Patent Application Publication
(10) Pub. No.: US 2007/0155366 A1
(43) Pub. Date: Jul. 5, 2007

(54) Method, apparatus, and system for biometric authentication of user identity

(76) Inventors: Deepak J. Manohar, Hillsboro, OR (US); Michael J. Covington, Hillsboro, OR (US); Manoj R. Sastry, Portland, OR (US); Farid Adrangi, Lake Oswego, OR (US); Shao-Cheng Wang, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/322,585

(22) Filed: Dec. 30, 2005

(51) Int. Cl. H04M 1/66

(52) U.S. Cl. 455/411; 380/247; 455/410

(57) ABSTRACT

Various methods and apparatuses are described for a portable computing device cooperating with a wireless phone handset. The portable computing device has a first wireless communication module that causes the portable computing device to act as a wireless base station. The portable computing device also has a biometric authentication module to authenticate access rights to applications and data files on the portable computing device based on one or more biometric features of the user of a wireless phone. The wireless phone may be a handset separate from the portable computing device. The wireless phone has a second wireless communication module configured to act as a wireless access device. The wireless phone also has a biometric sensor to convey the biometric features of the user of the wireless phone to the portable computing device.

### FIELD

Aspects of embodiments of the invention relate to computing systems and more particularly to wireless access to a base computing system.

### BACKGROUND

Voice Over IP (VOIP) is a telephone service that uses a wide area network, such as the Internet, as a global telephone network. VOIP offers a low cost telephone service. However, VOIP may not give a user security assurances similar to those offered by traditional circuit-switched telephone systems. Unlike the traditional phone, the open computing platform of mobile devices introduces usage models that may call for additional requirements for secure access to a computer-based phone.

### BRIEF DESCRIPTION OF THE DRAWINGS

The drawings refer to embodiments of the invention in which:

FIG. 1 illustrates a block diagram of an example computing system device cooperating with a wireless phone handset.

FIG. 2 illustrates a diagram of an embodiment of the wireless handset phone that becomes useable to make a VOIP phone call merely after the biometric authentication module authenticates the access rights of the user.

FIG. 3 illustrates a flow diagram of an embodiment of a call control sequence involved when a user places an outbound phone call from the remote wireless handset phone.

FIG. 4 illustrates a sequence diagram of an embodiment of a call control sequence involved when a user receives an inbound phone call on the remote wireless handset phone.

FIG. 5 illustrates a block diagram of multiple user accounts with different access rights to use the wireless handset phone in a secure manner.

While the invention is subject to various modifications and alternative forms, specific embodiments thereof have been shown by way of example in the drawings and will herein be described in detail. The embodiments of the invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, types of authentication, etc., in order to provide a thorough understanding of the embodiments of the invention. It will be apparent, however, to one of ordinary skill in the art that the embodiments of the invention may be practiced without these specific details. However, the specific numeric reference should not be interpreted as a literal sequential order but rather interpreted that the first module is different than a second module. Further, the voice of a wireless user will mainly be used as an identifiable biometric feature of the user. However, many other biometric features of a user may be implemented in various embodiments of the invention. Thus, the specific details set forth are merely exemplary. The specific details may be varied from and still be contemplated to be within the spirit and scope of the present invention.

In general, the various methods and apparatuses are described for a computing device cooperating with a wireless phone handset. Examples of a portable computing device may be a laptop computer, a personal digital assistant, or other similar device with on board processing power and wireless communications ability that is powered by a battery. The portable computing device has a first wireless communication module that causes the portable computing device to act as a wireless base station. The portable computing device also has a biometric authentication module to authenticate access rights to applications and data files on the portable computing device based on one or more biometric features of the user of a wireless phone. The wireless phone may be a handset separate from the portable computing device. The wireless phone has a second wireless communication module configured to act as a wireless access device. The wireless phone also has a biometric sensor, such as a speaker, a scanner for fingerprints, a digital camera for digital image recognition, etc to convey the biometric features of the user of the wireless phone to the portable computing device.

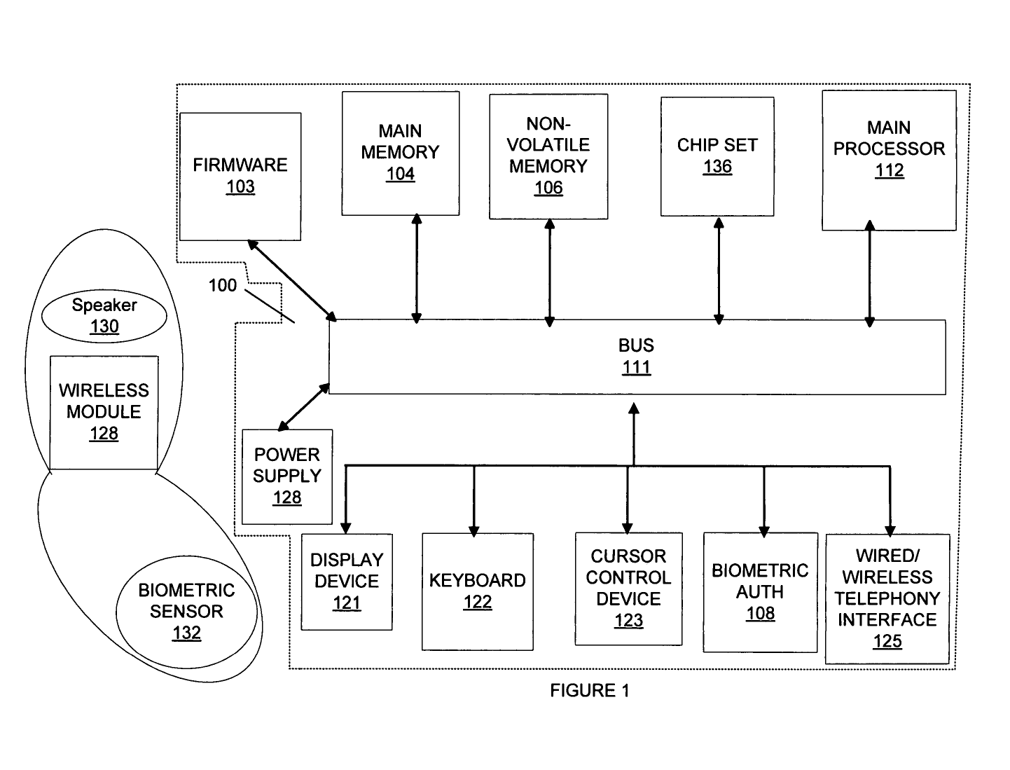

FIG. 1 illustrates a block diagram of an example computing system device cooperating with a wireless phone handset. A computing-device based phone may consist of two components: a software component running on the computing system 100 and a remote wireless handset 102 that interacts with the software component. In one embodiment, computing system 100 includes an internal communication mechanism such as a bus 111 for communicating information and an integrated circuit component such as a main processing unit 112 coupled with the bus 111 for processing information. One or more of the components or devices in the computer system 100 such as the main processing unit 112 or a chip set 136 may process instructions and data for the various modules in the computing system 100, such as the first wireless communication module 126 and the biometric authentication module 108.

The various modules in the computing system may be hardware circuits built from logic gates to perform a function, software containing code scripted to perform that function, or combinations of both that cooperate together to achieve that specific function. For example, the first wireless communication module 126 is configured to act as a wireless base station. The biometric authentication module 108 is configured to authenticate access rights to applications and data files on the portable computing device 100 based on one or more biometric features of the user of the wireless phone handset 102.

The first wireless communication module 126 may be a software application running on the portable computing device 100, which contains code scripted to act as a soft phone for Voice-over-IP (VOIP) application to facilitate a phone call as well as contains code scripted to establish a wireless connection with the wireless phone handset 102.

The wireless phone handset 102 may be separate from the portable computing device 100. The wireless phone handset 102 may have a second wireless communication module 128 configured to act as a wireless access device. The first communication module 126 and the second wireless communication module 128 may employ a Wireless Application Protocol such as Bluetooth™ to establish a wireless communication channel. See, e.g., Bluetooth Specification, Version 1.0A, released Jul. 24, 1999. An alternate wireless communication link may be established, such as a HomeRF™ link described in the Shared Wireless Access Protocol (SWAP) Specification 1.0, released Jan. 5, 1999. The wireless communication modules 126, 128 may also implement a wireless networking standard such as Institute of Electrical and Electronics Engineers (IEEE) 802.11 standard, IEEE std. 802.11-1999, published by IEEE in 1999.

The wireless phone handset 102 may have a biometric sensor 132, such as a microphone, a scanner for fingerprints, a digital camera for digital image recognition, etc to convey the biometric features of the user of the wireless phone handset 102 to the portable computing device 100.

The biometric authentication module 108 has a database of biometric templates of biometric features associated with one or more users. The templates of biometric features associated with the one or more users are used to identify a specific authorized user. The biometric authentication module 108 contains software code and/or logic circuits to challenge an identity of the user. The biometric authentication module 108 also contains software code and/or logic circuits to allow a user to configure how long a single biometric authentication of his user identity may be valid. The database, in the case of multiple user's, contains a first level of access privileges granted to a first biometrically identified user and a second level of access privileges granted to a second biometrically identified user. The level of access privileges between the two users may be different. For example, the second level of access privileges may be lower than the first level of access privileges. The access level privileges include user rights to access and modify various applications and data files on the laptop. Thus, each user may have their own access privileges, which may be the same or different from another user. A main application that the user has access to is a software-based application installed on the portable computing device 100 to make and receive VOIP phone calls. Some software-based phone applications may be commonly referred to as Soft phones. An example of this is Earthlink's Truevoice™.

In an embodiment, the wireless phone handset 102 consists of a speaker 130, a microphone 132, and a second wireless communication module 128 with hardware and software configured to establish wireless communications with the portable computing device 100. The wireless phone handset 102 may be designed to become useable to make any kind of phone call merely after the biometric authentication module 108 authenticates the access rights of the user.

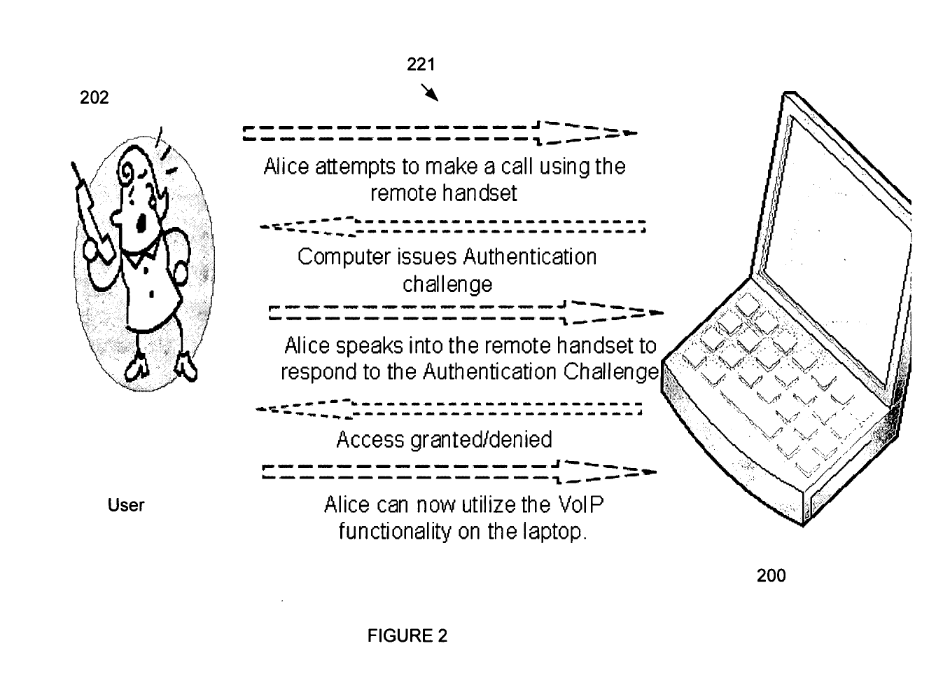

FIG. 2 illustrates a diagram of an embodiment of the wireless handset phone that becomes useable to make a VOIP phone call merely after the biometric authentication module authenticates the access rights of the user. The user, Alice, is using a remote wireless handset phone 202, such as Bluetooth handset phone, which has been paired with a VOIP partition. The wireless handset phone 202 may have a screen that can display a limited amount of information.

The user may enter into the short-range, wireless communication range of the portable computing device 200, such as a laptop, while carrying the wireless handset phone 202. Consequently, a short-range, wireless communication link, 221, is established between the portable computing device 200 and the wireless handset phone 202. As discussed, this short-range, wireless communication link 221 may be a Bluetooth™ link, a HomeRF™ link or similar secure wireless communication channel. The wireless handset phone 202 includes a transceiver circuit to establish wireless communications via a secure audio channel. The wireless handset phone 202 transmits an access code, which an audio card in the portable computing device 200 verifies to establish a secure communication channel. For example, a wireless connection pairing key (e.g., Bluetooth pairing key) between the remote handset and the computer-based soft-phone may be established. The secure communication channel between the remote wireless handset phone 202 and the audio card in the portable computing device 200 is then setup.

In an embodiment, the short-range, wireless communication link 221 is established automatically, in response to bringing the wireless handset phone 202 within the short-range, wireless communication range of the portable computing device 200. In other words, no user intervention is required to establish the wireless communication link 221 beyond entering the wireless communication range of the portable computing system 200 while carrying the wireless handset phone 202. For an alternate embodiment, the short-range, wireless communication link 221 is not established automatically but rather is established in response to the user pressing a button or otherwise entering information into the portable computing system 200 or the wireless handset phone 202. The display channel between the screen on the remote wireless handset phone 202 and the VOIP partition is also established.

In an embodiment, hardware-based partitioning capabilities, such as those provided by Intel's VT technology exist in the computer. With virtualization, one computer system can function as multiple “virtual” systems. One of the partitions is dedicated to running the VOIP software and other trusted value-added services provided as part of the platform. The hardware-based partitioned section may be referred to as the VOIP partition.

The user attempts to make a call using the remote wireless handset phone 202. The portable computing system 200 detects the request and issues a user authentication challenge. The user speaks into the remote wireless handset phone 202 to respond to the user authentication challenge.

The user's voice authenticates herself using the remote wireless handset phone 202 to her portable computing system 200. The biometric authentication module in the portable computing system 200 authenticates access rights to applications and data files on the portable computing device 200 based on at least the voice of the user of the wireless handset phone 202.

After verification of the user's identity, access is granted or denied to the user of the wireless handset phone 202. If access is granted to make a phone call, then the user may now utilize the VOIP functionality installed in the portable computing system 200.

The remote wireless handset phone 202 of any user party can easily place a phone call or access any of the functions such as sending/receiving files/emails, provided by the computer-based phone even if the laptop screen were locked requiring a user password to unlock the laptop. Each user can make calls using the laptop's VOIP (Voice over IP) connection. The user can also access all the files on the user's laptop using this remote handset.

In one scenario, the user might be far away from the laptop, thus making it virtually impossible for the user to authenticate herself to the VOIP partition using the laptop's keyboard. In such a situation, the user would have to authenticate using the wireless handset phone 202 itself. The remote wireless handset phone 202 may not support user friendly text entry due to a small display or tiny keys. A Personal Identification Number (PIN)-based technique could be used but a very long PIN would have to be used to match the entropy of a text based password. Such a long manually typed PIN may not be very user-friendly.

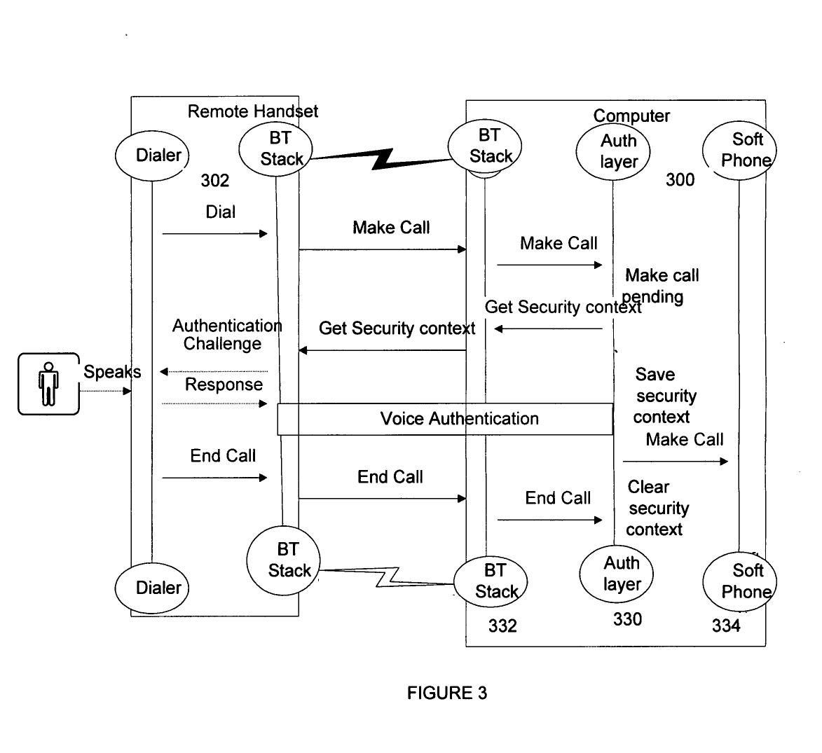

FIG. 3 illustrates a flow diagram of an embodiment of a call control sequence involved when a user places an outbound phone call from the remote wireless handset phone. In the VOIP partition on the computer 300 there is an authentication layer 330, which includes the biometric identification module. The authentication layer 330 is between a BlueTooth stack 332 and the soft phone application 334. The authentication layer 330 is responsible for authenticating the user before allowing access to files and applications installed on a machine readable storage medium of the computer 300.

A minimally intrusive biometric authentication mechanism uses voice-based authentication. The user is about to make or receive a call and the user is already conditioned to placing the remote handset next to his mouth. The user speaks into the remote phone handset 302 and this speech with its unique voice characteristics is securely transmitted back to the VOIP partition on the computer 300 where the speech characteristics are compared against the authentication template. The results of the comparison either grant access with a certain level of access privileges or deny access.

An authorized user will generally have access to a VOIP soft phone application 334 installed on the computer 300. Voice mail, caller ID, call forwarding and a Soft phone option are typically part of a VOIP package. The computing device 300 may also have a sound card and VOIP router with a telephone adapter, broadband router, wireless access point, and local area network functionality to support the VOIP application. The computing device 300 runs the Soft phone application 334 and stores its instructions in its memory.

Soft phones can work as stand-alone phones or be part of an IP Private Branch Exchange (PBX) family. The software-based phone for voice over IP offers the full range of phone features, such as call forwarding and conference calling, and also provide integration with applications such as Microsoft Outlook™ for automatic phone dialing. VOIP applications integrate with their computer so a soft phone application on the lap top allows the computer to make a phone call over the Internet.

The sequence of steps depicted in FIG. 3 is described as follows. The user initiates a call from the remote phone handset 302 by dialing. The wireless phone handset 302 establishes a secure wireless connection between itself and the computing device 300. Before the phone call request reaches the soft phone software component 334 on the computer 300, this request passes through the authentication layer 330. The authentication layer 330 monitors all incoming communications from the wireless phone handset 302. The authentication layer 330 checks to see if the user is currently authenticated. If the user has not been authenticated, the authentication layer 330 issues a challenge to the user on the wireless phone handset 302, with the “Get Security Context” command and the authentication layer 330 marks the user's request (Make call) as pending.

The authentication layer 330 may have a database of biometric templates of biometric features associated with one or more users. The authentication layer 330 may have a database of the access level to various applications and data files on the laptop and other privileges associated with the one or more users.

The biometric authentication module contains software code or logic circuits to allow a user to configure how long a single biometric authentication of his user identity may be valid. The security context associated with that user may be cleared causing the authentication layer to verify the identity of the user each time a wireless access/phone call is completed/hung up. The security context associated with that user may also be programmed to continue to remain valid from that wireless phone for a programmable period of time after wireless access/phone call is completed/hung up. The security context associated with that user may also be programmed to continue to remain valid from that wireless phone until the user activates icons to log off the secure wireless connection with the lap top, etc.

An example software component of the authentication layer in a Windows™ operating system environment is the Kerberos™ authentication protocol. A Kerberos™ client may be implemented as a security provider through the Security Support Provider Interface. Initial authentication is integrated with the user sign-on architecture. The Kerberos™ protocol relies heavily on an authentication technique involving shared secrets. The basic concept is quite simple: If a secret is known by only two people/devices, then either person/device can verify the identity of the other by confirming that the other person/device knows the secret.

Another example software component of the authentication layer is Common Data Security Architecture (CDSA), etc. The CDSA is a set of layered security services and cryptographic framework that provide an infrastructure for creating cross-platform, interoperable, security-enabled applications for client-server environments.

As discussed above, if the user has not already been authenticated, the authentication layer 330 issues a challenge to the user on the remote phone handset 302.

The remote phone handset 302 prompts the user, either visually using the display or audibly using the speaker, to respond to the challenge. The identity challenge may be that the authentication of the identity of the user is based 1) on voice recognition alone or 2) based on voice recognition and potentially either the user must speak a specific password that also has the corresponding verifiable voice characteristics of the user or the system generates a random phrase that the user must repeat back the phrase to the authentication layer 330.

The user responds appropriately and the response is transmitted back to the authentication layer 330. The authentication layer 330 then performs voice-based authentication based on existing techniques. On authentication the authentication layer 330 stores the security context. The user's pending request (Make call) is then allowed to proceed.

The wireless phone handset 302 then utilizes the soft phone application 334 running on the computer 330. The software based phone application 334 dials the number and makes the phone call using VOIP. The user need not physically interact with the traditional input devices to make/receive a call from the software based phone application 334 on the computer 300. Merely, the user can access the computer 300 using the remote phone handset 302 in a secure manner.

When the user terminates the session with an “End call” command the security context may be cleared by the authentication layer 330 depending on the programming selected by the user. Thus, the call control sequence can provide voice based authentication on a per-call-session basis or just a per session basis.

The computer 300 while in sleep mode during an inbound call or outbound call will merely wake the applications and or components in the domain needed to make the phone call. Thus, the computer 300 needs to power up fewer devices (such as the primary display, keyboard, mouse) when user makes or receives a call from remote handset.

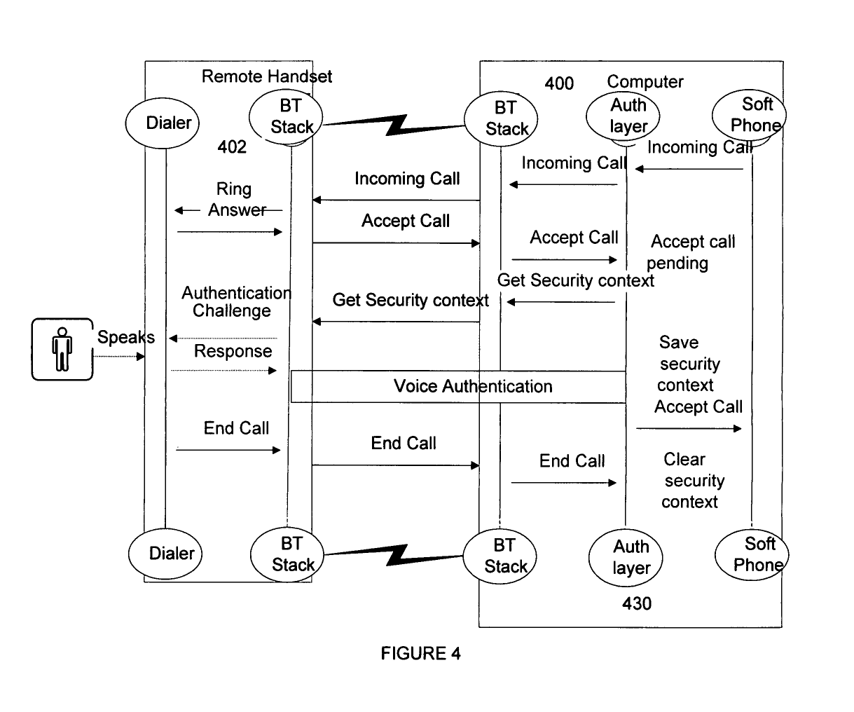

FIG. 4 illustrates a sequence diagram of an embodiment of a call control sequence involved when a user receives an inbound phone call on the remote wireless handset phone. The operations are similar to FIG. 3 except where noted. On the inbound call, the user may again be asked to authenticate herself before she can receive the call. Once authenticated the authentication layer 430 will send out the accept call command to the soft phone which in turn sends out a message to the calling party. The voice authentication should not add much delay before the call is accepted.

In both cases of inbound calls and outbound calls, once the user is authenticated the authentication layer stores some security context. This security context may be cleared when the user terminates the call or be time period session-based. The user merely needs to authenticate herself for every session of use from the remote wireless handset phone to the computer.

The approach described above allows integrating voice-based security with the call control sequence to achieve voice-authenticated sessions. The biometric identification of a user prevents misuse of the wireless handset phone by unauthorized parties. The biometric identification of a user also prevents unauthorized users on rogue remote wireless handset phones from misusing the computing system resources. Furthermore, consider the case where the software component is running on a laptop with several devices (primary display, keyboard, mouse) turned off. Now, if the user can authenticate himself using the remote phone handset, the laptop need not power up these devices thus allowing fewer devices to be powered up. Also, multiple users may be authorized to use the wireless pone handset but have different access level privileges.

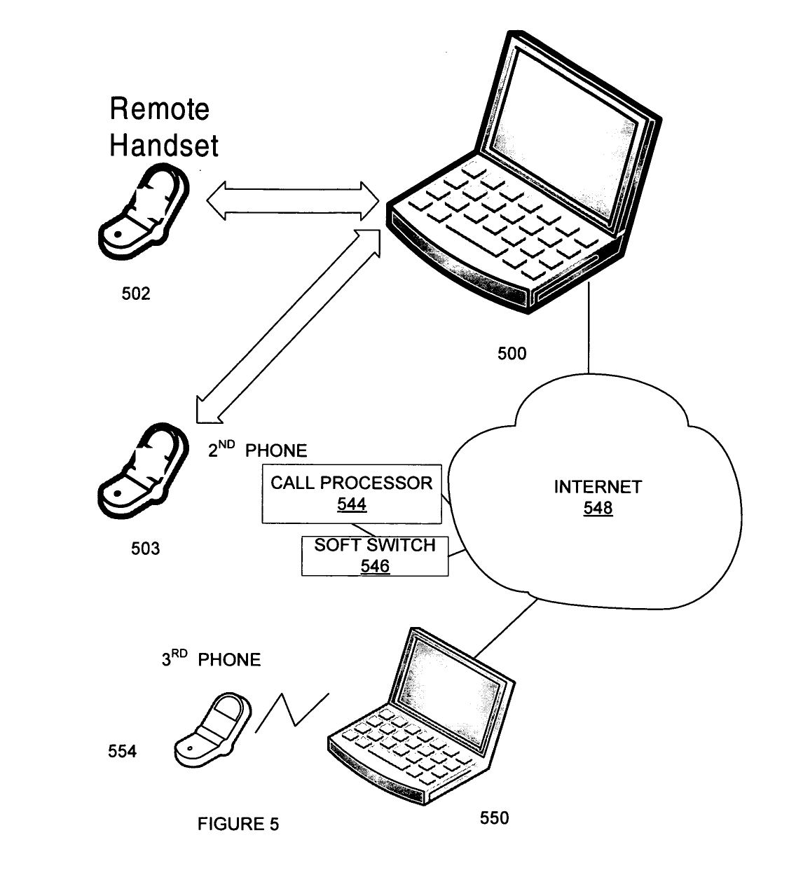

FIG. 5 illustrates a block diagram of multiple user accounts with different access rights to use the wireless handset phone in a secure manner. In this example, two wireless handset phones 502, 503 are trying to establish a link with the computer 500. Each user authenticates herself using their respective wireless handset phone 502, 503 to a soft phone running on a computer 500. The biometric identification of a user provides a distinctive security feature in a platform that allows for less intrusive and more natural remote user authentication. The biometric identification of a user provides for secure, remote voice-based authentication to a computer 500 via the wireless handset phone 502, 503. Each user of a wireless handset phone 502, 503 may have different access rights.

Also, the user of the second wireless handset phone 503 may be an attacker using this rogue handset to use the soft phone application on the computer. Accordingly, in an embodiment, authentication of the user of the remote handset to the phone software running on the computer is required before allowing any access. The attacker is not able to meet the authentication challenge and thus is denied access. The wireless phone includes a wireless microphone and speaker combination with software configured to establish wireless communications with the computer and merely becomes useable to make any kind of phone call after biometric authentication occurs on the computing device.

Computing devices and telephony can converge to yield a powerful, open, Internet-based communications platform. For Internet-based telephony to be successful, the computer platform should provide security assurances similar to those offered by traditional circuit-switched telephone systems. The form factor for these wireless handset phones may resemble a cell phone. However, unlike the traditional phone, the open computer platform introduces new usage models that call for additional requirements for secure access to the computer-based phone.

Another example operation of the wireless phone having a biometric sensor to convey the biometric features of the user of the wireless phone to the computing device is as follows. The VOIP software in the computing device takes analog audio signals from the wireless phone and turns them into digital data that can be transmitted over the Internet. On the other end of the VOIP call, there can be any combination of 1) traditional analog phones, or 2) software based-IP phones as acting as a voice transmission and reception user interface. On the other end of the VOIP call, there can be any combination of 1) an analog telephone adaptor (ATA) working with a codec or 2) client VOIP soft phone software working with a codec to handle the digital-to-analog conversion of the voice conversation. Facilitating the VOIP call can be soft switches to map the calls.

With VOIP, the user of the first wireless handset phone 502 can make a call from anywhere there is broadband connectivity. VOIP based phones can be administered by a provider anywhere there is a broadband connection since the wireless handset phone 502, via the VOIP software in the computer 500, broadcasts its info over the Internet. So business travelers can take their wireless handset phones 502, 503 with them on trips and always have access to their home phone.

As discussed previously, a VOIP soft phone is client software that loads the VOIP service onto the first computing device 500, such as a desktop or laptop. The VOIP soft phone displays a graphic user interface that looks like a traditional telephone on the computer screen of the first computing device 500 and handset screen of the first wireless handset phone 502.

The first computing device 500 and the second computing device 550 may both have service through a VOIP provider. The VOIP application in both computing devices use software, a sound card and an Internet connection 548. The Internet Service Provider may administer the VOIP connection.

The first wireless handset phone 502 sends a signal to the soft phone application, via the authentication layer, running on the first computer 500. The first computing device 500 biometrically authenticates the identity of the user as previously described.

The soft phone application receives the signal and sends a dial tone. This lets the user of the first wireless handset phone 502 know that a connection to the Internet 548 has been established.

The user of the first wireless handset phone 502 dials the phone number of the party the user wishes to talk to. The tones are converted by the soft phone application into digital data and temporarily stored.

The phone number data is sent in the form of a request to the user's VOIP company's call processor 544. The call processor 544 checks it to ensure that it is in a valid VOIP format. The central call processor 544 is a piece of hardware running a specialized database/mapping program called a soft switch 546.

The call processor 544 determines to whom to map the phone number. In mapping, the phone number is translated to an IP address. The soft switch 546 connects the two devices on either end of the call. On the other end, a signal is sent to the second computing device 550 running a VOIP application, telling it to ask the connected third phone 554 to ring.

Thus, soft switches use a standard based on a numbering system so that the VOIP provider's network know where to route a call based on the numbers entered into the phone keypad. In that way, a phone number is like an address. IP addresses correspond to a particular device on the network, such as the Internet 548. The device on the network can be a computer, a router, a switch, a gateway or, even a telephone. IP addresses may not always be static. They can be assigned by a Dynamic Host Configuration Protocol server on the network and generally change with each new connection. So the challenge with VOIP is figuring out a way to translate the phone numbers to IP addresses and then finding out the current IP address of the requested number. This is the mapping process and is handled by the central call processor 544 running a soft switch 546. The soft switch 546 performs the database lookup and mapping. The user and the phone and/or computer associated with that user are treated as one unit called the endpoint. The soft switch 546 connects the two different endpoints. The soft switches knows 1) where the endpoint is on the network, 2) what phone number is associated with that endpoint, and 3) the current IP address assigned to that endpoint from the packet header information.

So when a call is placed using VOIP, a request is sent to the soft switch 546 asking which endpoint is associated with the dialed phone number and what that endpoint's current IP address is. The soft switch 546 contains a database of users and phone numbers. If the soft switch 546 does not have the information it needs, the soft switch 546 hands off the request downstream to other soft switches until it finds one that can answer the request. Once the soft switch 546 finds the destination phone location, the soft switch 546 locates the current IP address of the device associated with that third phone 554 in a similar series of requests. The soft switch 546 sends back all the relevant information to the soft phone application, allowing the exchange of data between the two endpoints. The soft switches work in tandem with the devices on the network to make VOIP possible.

Once a user of a third phone 554 picks up the phone, a communication session is established between the first computing device 500 and the second computing device 550. This means that each system knows to expect packets of data from the other system. In the middle, the normal Internet infrastructure handles the call as if it were e-mail or a Web page. Each system may use the same protocol to communicate. The system implements two channels, one for each direction, as part of the session.

The user of the first wireless handset phone 502 talks for a period of time. The soft phone application uses a codec, which stands for coder-decoder, that converts an audio signal into a compressed digital form for transmission and then back into an uncompressed audio signal for replay. The codec samples the audio signal from the first wireless phone 502 and the third wireless phone 554. During the conversation, the first computing device 500 and the second computing device 550 transmit packets back and forth when there is data to be sent. The soft phone applications at each end translate these packets as they are received and convert them to the analog audio signal that the users hear. When the samples are reassembled, the pieces of audio missing between each sample are so small that to the human ear, it sounds like one continuous signal of audio signal. The soft phone application also keeps the communication circuit open between the first computing device 500 and the second computing device 550 while it forwards packets to and from the IP host at the other end.

Thus, when the user of a handset user utters sound into the microphone, the packet-switching technology creates individual packets of noisy bytes instead of sending a continuous stream of bytes (both silent and noisy). The VOIP technology uses the Internet's packet-switching capabilities to provide phone service. The packet-switching technology opens a brief connection—just long enough to send a small chunk of data, called a packet, from one system to another. The sending computer chops data into small packets, with an address on each one telling the network devices where to send them. Inside of each packet is a payload. The payload is a piece of audio file that is being transmitted inside the packet. The sending computer sends the packet to a nearby router in the Internet 548 and forgets about it. The nearby router sends the packet to another router that is closer to the recipient computer. That router sends the packet along to another, even closer router, and so on. When the receiving computer finally gets the packets (which may have all taken completely different paths to get there), it uses instructions contained within the packets to reassemble the data into its original state. Packet switching also frees up the two computers communicating with each other so that they can accept information from other computers, as well.

The user of the first wireless handset phone 502 may finish talking and hang up the receiver. When the user of the first wireless handset phone 502 hangs up, the communication channel is closed between the first computing device 500 and the second computing device 550. The soft phone application sends a signal to the soft switch 546 connecting the call, terminating the session.

Referring to FIG. 1, computer system 100 also further comprises a random access memory (RAM) or other dynamic storage device 104 (referred to as main memory) coupled to bus 111 for storing information and instructions to be executed by main processing unit 112. Main memory 104 also may be used for storing temporary variables or other intermediate information during execution of instructions by main processing unit 112.

Firmware 103 may be a combination of software and hardware, such as Electronically Programmable Read-Only Memory (EPROM) that has the operations for the routine recorded on the EPROM. The firmware 103 may embed foundation code, basic input/output system code (BIOS), or other similar code. The firmware 103 may make it possible for the computer system 100 to boot itself.

Computer system 100 also comprises a read-only memory (ROM) and/or other static storage device 106 coupled to bus 111 for storing static information and instructions for main processing unit 112. The static storage device 106 may store OS level and application level software.

Computer system 100 may further be coupled to or have an integral display device 121, such as a cathode ray tube (CRT) or liquid crystal display (LCD), coupled to bus 111 for displaying information to a computer user. A chipset may interface with the display device 121.

An alphanumeric input device (keyboard) 122, including alphanumeric and other keys, may also be coupled to bus 111 for communicating information and command selections to main processing unit 112. An additional user input device is cursor control device 123, such as a mouse, trackball, trackpad, stylus, or cursor direction keys, coupled to bus 111 for communicating direction information and command selections to main processing unit 112, and for controlling cursor movement on a display device 121. A chipset may interface with the input output devices.

Another device that may be coupled to bus 111 is a power supply such as a battery and an alternating current adapter circuit. Furthermore, a sound recording and playback device, such as a speaker and/or microphone (not shown) may optionally be coupled to bus 111 for audio interfacing with computer system 100. Another device that may be coupled to bus 111 is a wireless communication module 125.

In one embodiment, the software used to facilitate the routine can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The concept can accommodate most any biometric technique, and appropriate remove handset device. For example, other remote handset phone devices, such as the TTY used by hear-impaired users, could incorporate biometric sensors such as fingerprint scanners, digital cameras for image comparison, or other more appropriate biometric technologies. The authentication may require two or more biometric features such as voice and face. The main processing unit 112 may consist of one or more processor cores working together as a unit. Also, a cell phone that has access to satellite communications network may also run an embodiment of the wireless communications software that cooperates with the soft phone application running on the portable computing device. This would allow the cell phone user to avoid roaming charges and areas of non-satellite coverage by simply establishing a connection with the Internet. The invention is to be understood as not limited by the specific embodiments described herein, but only by scope of the appended claims.

What is claimed is:

1. An apparatus, comprising:
a computing device having a first wireless communication module acting as a wireless base station and a biometric authentication module to authenticate access rights to applications on the computing device based on a first biometric feature of a user of a wireless phone, wherein the wireless phone is a handset separate from the computing device and has a second wireless communication module configured to act as a wireless access device and has a biometric sensor to convey the first biometric feature of the user of the wireless phone to the computing device.

2. The apparatus of claim 1, wherein the biometric sensor is a microphone to convey the biometric feature of the user and the biometric feature is the voice of the user.

3. The apparatus of claim 1, wherein the biometric authentication module has a database of biometric templates of biometric features associated with one or more users of the wireless phone.

4. The apparatus of claim 3, wherein the database contains a first level of access privileges associated with a first biometrically identified user and a second level of access privileges associated with a second biometrically identified user, and the second level of access privileges is lower than the first level of access privileges.

5. The apparatus of claim 1, wherein the first wireless communication module is a software application installed on the computing device, which contains code scripted to act as a soft phone for a Voice over IP application to facilitate a phone call as well as contains code scripted to establish a wireless connection with the wireless phone.

6. The apparatus of claim 1, wherein the wireless phone comprises a speaker, a microphone, and software containing code scripted to establish wireless communications with the computing device and to become useable to make any kind of phone call merely after the biometric authentication module authenticates access rights of the user.

7. The apparatus of claim 1, wherein the computing device is a laptop computer.

8. The apparatus of claim 1, wherein the biometric authentication module is configurable by the user to configure how long a single biometric authentication of the user's identity may be valid.

9. The apparatus of claim 1, wherein the biometric sensor is a digital camera to convey a digital image of the user to the biometric authentication module.

10. The apparatus of claim 1, wherein the biometric authentication module to generate a random phrase as an identity challenge that the user must repeat back the phrase to the biometric authentication module.

11. The apparatus of claim 1, wherein the computing device is a portable computing device that has a partition dedicated to running Voice over IP software as well as the biometric authentication module.

12. A method, comprising:
establishing a secure wireless communication channel between a computing device and a wireless phone;
authenticating access rights to applications and data files on the portable computing device based on a first biometric feature of a user of the wireless phone; and
receiving the first biometric feature of the user of the wireless phone to authenticate an identity of the user.

13. The method of claim 12, further comprising:
authenticating the identity of the user based on the user's voice compared to a template of biometric features associated with one or more users of the wireless phone.

14. The method of claim 12, further comprising:
granting a first level of access privileges associated with a first biometrically identified user and a second level of access privileges to a second biometrically identified user, wherein the second level of access privileges is different than the first level of access privileges.

15. The method of claim 12, further comprising:
allowing a user to configure how long a single biometric authentication of the user's identity may be valid.

16. A system, comprising:
a wireless phone having a first wireless communication module configured to act as a wireless access device; and
a computing device having
a second wireless communication module configured to act as a wireless base station,
a biometric authentication module to authenticate access rights to applications on the computing device based on a first biometric feature of a user of the wireless phone,
a non-volatile memory to store a template of the first biometric feature of the user, and
a Voice over IP application to facilitate a phone call, wherein the wireless phone also has a biometric sensor to convey the first biometric feature of the user of the wireless phone to the computing device.

17. The system of claim 16, wherein the biometric sensor is a microphone to convey the biometric feature of the user and the biometric feature is the voice of the user.

18. The system of claim 16, wherein the biometric authentication module has a database of templates of biometric features associated with one or more users of the wireless phone and the database contains a first level of access privileges associated with a first biometrically identified user and a second level of access privileges is granted to a second biometrically identified user, and the second level of access privileges is different than the first level of access privileges.

19. The system of claim 16, wherein the computing device is a laptop computer.

20. The system of claim 16, wherein the biometric authentication module to store a spoken password as an identity challenge that the user must speak the password with the specific voice characteristics of the user to the biometric authentication module to verify the identity of the user.

21. The system of claim 16, wherein the biometric authentication module to generate a random phrase as an identity challenge that the user must speak the random phrase with the specific voice characteristics of the user to the biometric authentication module to verify the identity of the user.

22. The apparatus of claim 1, wherein the biometric sensor is a fingerprint scanner to convey a fingerprint of the user to the biometric authentication module.

23. A system, comprising:
a call processor having a mapping module to receive a dialed phone number request in a Voice over IP (VOIP) format from a first computing device having
a wireless communication module configured to act as a wireless base station with a wireless phone,
a VOIP soft phone application installed on the first computing device, and
a biometric authentication module to authenticate access rights to applications on the computing device based on a first biometric feature of a user of the wireless phone, wherein the mapping module to map the dialed phone number from the wireless phone to an IP address in order to establish a VOIP communication channel between the first computing device and a second computing device.

24. The system of claim 23, wherein the mapping module is a soft switch that translates the dialed phone number from the wireless phone into the IP address and then sends a signal to the second computing device instructing the second computing device to have its associated phone to ring.

25. The system of claim 23, wherein the first computing device is a laptop computer.
